(19) United States
(12) Patent Application Publication
(10) Pub. No.: US 2006/0215934 A1
(43) Pub. Date: Sep. 28, 2006

(54) Online registration of dynamic scenes using video extrapolation

(75) Inventors: Shmuel Peleg, Mevaseret Zion (IL); Alexander Rav-Acha, Jerusalem (IL); Yael Pritch, Jerusalem (IL)

Correspondence Address: BROWDY AND NEIMARK, P.L.L.C.;624 NINTH STREET, NW, SUITE 300, WASHINGTON, DC, 20001-5303, US

(73) Assignees: Yissum Research Development Co of the Hebrew University of Jerusalem Israeli Co, Jerusalem (IL); HumanEyes Technologies Ltd. Israeli Co, Jerusalem (IL)

(21) Appl. No.: 11/378,635

(22) Filed: Mar. 20, 2006

Related U.S. Application Data
(60) Provisional application No. 60/664,821, filed on Mar. 25, 2005.
(60) Provisional application No. 60/714,266, filed on Sep. 7, 2005.

(51) Int. Cl. G06K 9/32

(52) U.S. Cl. 382/294

(57) ABSTRACT

A computer-implemented method and system determines camera movement of a new frame relative to a sequence of frames of images containing at least one dynamic object and for which relative camera movement is assumed. From changes in color values of sets of pixels in different frames of the sequence for which respective locations of all pixels in each set are adjusted so as to neutralize the effect of camera movement between the respective frames in the sequence containing the pixels, corresponding color values of the pixels in the new frame are predicted and used to determine camera movement as a relative movement of the new frame and the predicted frame. An embodiment of the invention maintains an aligned space-time volume of frames for which camera movement is neutralized and adds each new frame to the aligned space-time volume after neutralizing camera movement in the new frame.

### RELATED APPLICATION

This application claims the benefit of U.S. Provisional application Ser. Nos. 60/664,821 filed Mar. 25, 2005 and 60/714,266 filed Jul. 9, 2005 the contents of which are wholly incorporated herein by reference.

### FIELD OF THE INVENTION

This invention relates to motion computation between frames in a sequence.

### REFERENCES

[1] Z. Bar-Joseph, R. El-Yaniv, D. Lischinski, and M. Werman. Texture mixing and texture movie synthesis using statistical learning. IEEE Trans. Visualization and Computer Graphics, 7(2):120-135, 2001;
[2] J. Bergen, P. Anandan, K. Hanna, and R. Hingorani. Hierarchical model-based motion estimation. In European Conference on Computer Vision (ECCV'92), pages 237-252, Santa Margherita Ligure, Italy, May 1992.
[3] F. C. Crow. Summed-area tables for texture mapping. In SIGGRAPH '84, pages 207-212, 1984.
[4] G. Doretto, A. Chiuso, S. Soatto, and Y Wu. Dynamic textures. IJCV, 51(2):91-109, February 2003.
[5] A. Efros and T. Leung. Texture synthesis by non parametric sampling. In International Conference on Computer Vision, volume 2, pages 1033-1038, Corfu, 1999.
[6] A. Fitzgibbon. Stochastic rigidity: Image registration for nowhere-static scenes. In International Conference on Computer Vision (ICCV'01), volume I, pages 662-669, Vancouver, Canada, July 2001.
[7] M. Irani and P. Anandan. Robust multi-sensor image alignment. In International Conference on Computer Vision (ICCV'88), pages 959-966, Bombay, India, January 1998.
[8] V. Kwatra, A. Schdl, I. Essa, G. Turk, and A. Bobick. Graphcut textures: Image and video synthesis using graphcuts. ACM Transactions on Graphics, SIGGRAPH 2003, 22 (3):277-286, July 2003.
[9] R. Vidal and A. Ravichandran. Optical flow estimation and segmentation of multiple moving dynamic textures. In CVPR, pages 516-521, San Diego, USA, June 2005.
[10] Y. Wexler, E. Shechtman, and M. Irani. Space-time video completion. In IEEE Conference on Computer Vision and Pattern Recognition (CVPR), volume 1, pages 120-127, Washington, D.C., June 2004.

### BACKGROUND OF THE INVENTION

When a video sequence is captured by a moving camera, motion analysis is required for many video editing and video analysis applications. Most methods for image alignment assume that a dominant part of the scene is static, and also assume brightness constancy. These assumptions are violated in scenes with moving objects or with dynamic background, cases where most registration methods will likely fail.

A pioneering attempt to perform motion analysis in dynamic scenes was suggested in [6]. In this work, the entropy of an auto-regressive process was minimized with respect to the motion parameters of all frames. But the implementation of this approach may be impractical for many real scenes. First, the auto-regressive model is restricted to scenes which can be approximated by a stochastic process, and it cannot handle dynamics such as walking people. In addition, in [6] the motion parameters of all frames are computed simultaneously, resulting in a difficult non-linear optimization problem. Moreover, extending this method to cases with multiple dynamic textures requires segmenting the scene into its different dynamic textures [9]. Such segmentation imposes an additional processing overhead.

Unlike computer motion analysis, humans can easily distinguish between the motion of the camera and the internal dynamics in the scene. For example, we can virtually align an un-stabilized video of a sea, even when the waves are constantly moving. The key to this human ability is an assumption regarding the simplicity and consistency of scenes and of their dynamics: It is assumed that when a video is aligned, the dynamics in the scene become smoother and more predictable. This allows humans to track the motion of the camera even when no apparent registration information exists. Humans therefore try to replace the “brightness constancy assumption” with a “dynamics constancy assumption”. This is done intuitively by humans but no comparable mechanism has been proposed in the art to allow this to be done automatically by computer.

Video motion analysis traditionally aligns two successive frames. This approach may work well for static scenes, where one frame can predict the next frame up to their global relative motion. But when the scenes are dynamic, the global motion between the frames is not enough to predict the successive frame, and global motion analysis between such two frames is likely to fail.

It would therefore be desirable to provide a computer-implemented method and system for performing motion analysis of a dynamic scene, which does not require segmenting the scene into its different dynamic textures.

It would also be desirable to provide such a method and system that distinguish between the motion of the camera and the internal dynamics in the scene.

It will also be appreciated that determining camera movement of a video frame is frequently a first stage in subsequent image processing techniques, such as image stabilization, display of stabilized video, mosaicing, image construction, video editing, object insertion and so on.

Within the context of the invention and the appended claims the term “video” denotes any series of image frames that when displayed at sufficiently high rate produces the effect of a time varying image. Typically, such image frames are generated using a video camera; but the invention is not limited in the manner in which the image frames are formed and is equally applicable to the processing of image frames created in other ways, such as animation, still cameras adapted to capture repetitive frames, and so on.

### SUMMARY OF THE INVENTION

In accordance with a first aspect of the invention there is provided a computer-implemented method for determining camera movement of a new frame relative to a sequence of frames of images containing at least one dynamic object and for which relative camera movement is assumed, said method comprising:

from changes in color values of sets of pixels in different frames of said sequence for which respective locations of all pixels in each set are adjusted so as to neutralize the effect of camera movement between the respective frames in said sequence containing said pixels, predicting corresponding color values of said pixels in the new frame so as to create a predicted frame or part thereof;

storing data representative of the predicted frame or part thereof; and

determining said camera movement as a relative movement of the new frame and the predicted frame or part thereof.

In accordance with a second aspect of the invention there is provided a computer-implemented method for determining camera movement relative to a sequence of frames of images containing at least one dynamic object and for which there exists an aligned space-time volume of frames for which camera movement between said frames is neutralized, said method comprising:

from changes in color values of pixels in different frames of the aligned space-time volume, predicting corresponding color values of said pixels in a new frame so as to create a predicted frame or part thereof;

storing data representative of the predicted frame or part thereof; and

determining said camera movement as a relative movement of the new frame and the predicted frame or part thereof.

Thus in accordance with the invention, a pre-aligned space-time volume of image frames is used to align subsequent frames, which may then be added to the aligned space-time volume. Since forming an aligned space-time volume requires all pixels in each frame thereof to be computed so as to remove the effect of camera motion, this requires significant computer resources. These may be reduced by storing respective camera motion parameters pertaining to each image frames in the space-time volume and using these parameters to neutralize the effect of camera motion in respect of only those pixels in each frame that are subsequently processed. This obviates the need to align the whole space time volume, thus saving computer resources and/or allowing computation of a predicted frame to be done in less time.

According to a further aspect of the invention there is provided a system for determining camera movement of a new frame relative to a sequence of frames of images containing at least one dynamic object and for which relative camera movement is assumed, said system comprising:

a memory for storing data representative of said sequence of frames of images, said data including color values of pixels in said frames and respective camera motion parameters for each frame;

a camera motion processor coupled to said memory for processing sets of pixels in different frames of said sequence so as to adjust locations of all pixels in each set for neutralizing the effect of camera movement between the respective frames in said sequence containing said pixels;

a frame predictor coupled to said a camera motion processor for predicting corresponding color values of said pixels in the new frame so as to create a predicted frame or part thereof; and

a comparator coupled to the frame predictor for determining said camera movement as a relative movement of the new frame and the predicted frame or part thereof.

According to yet a further aspect of the invention there is provided a system for determining camera movement relative to a sequence of frames of images containing at least one dynamic object, said system comprising:

a memory for storing data representative of an aligned space-time volume of frames for which camera movement between said frames is neutralized, said data including color values of pixels in said frames;

a frame predictor coupled to said memory and responsive to changes in color values of pixels in different frames of the aligned space-time volume for predicting corresponding color values of said pixels in a new frame so as to create a predicted frame or part thereof; and

a comparator coupled to the frame predictor for determining said camera movement as a relative movement of the new frame and the predicted frame or part thereof.

### BRIEF DESCRIPTION OF THE DRAWINGS

In order to understand the invention and to see how it may be carried out in practice, some embodiments will now be described, by way of non-limiting example only, with reference to the accompanying drawings, in which:

FIGS. 1a and 1b show pictorially a method for extrapolating a video using similar blocks from earlier video portions;

FIG. 2a shows pictorially a video frame of a penguin in flowing water;

FIGS. 2b and 2c compare pictorially image averages after registration of the video using a prior art 2D parametric alignment and extrapolation according to an embodiment of the invention, respectively;

FIG. 3a shows pictorially a video frame of a bear in flowing water;

FIGS. 3b and 3c compare pictorially image averages after registration of the video using a prior art 2D parametric alignment and extrapolation according to an embodiment of the invention, respectively;

FIGS. 4a, 4b and 4c show three frames of a sequence of moving flowers taken by a panning camera;

FIGS. 5a and 5b show respectively an original frame of waterfall sequence, and an image average after stabilizing this sequence according to an embodiment of the invention;

FIGS. 6 and 7 are flow diagrams showing the principal operations carried out in accordance with alternative embodiments of the invention for determining camera movement in a sequence of image frames containing at least one dynamic object;

FIGS. 8 and 9 are flow diagrams showing the principal operations carried out in accordance with alternative embodiments of the invention for predicting corresponding color values of pixels in a new frame; and

FIG. 10 is a block diagram showing functionality of a system according to an embodiment of the invention for determining camera motion relative to a sequence of image frames.

### DETAILED DESCRIPTION OF EMBODIMENTS

### Video Alignment with Dynamic Scenes

Video motion analysis traditionally aligns two successive frames. This approach may work well for static scenes, where one frame can predict the next frame up to their global relative motion. But when the scenes are dynamic, the global motion between the frames is not enough to predict the successive frame, and global motion analysis between such two frames is likely to fail. In accordance with the invention, the assumptions of static scenes and brightness constancy are replaced by a much more general assumption of consistent image dynamics: “What happened in the past is likely to happen in the future”. We will now describe how a video be extrapolated using this assumption, and how this extrapolation can be used for image alignment.

### Dynamics Constancy Assumption

Let a video sequence consist of frames I₁ . . . I_{N}. A space-time volume V is constructed from this video sequence by stacking all the frames along the time axis, V (x, y, t)=Iₜ(x, y). The “dynamics constancy” assumption implies that when the volume is aligned (e.g., when the camera is static), we can estimate a large portion of each image Iₙ=V (x, y, n) from the preceding frames I₁ . . . Iₙ₋₁. We will denote the space-time volume constructed by all the frames up to the k^{th} frame by V(x,y,\overline{k}). According to the “dynamics constancy” assumption, we can find an extrapolation function over the preceding frames such that
Iₙ(x,y)=V(x,y,n)≈Extrapolate(V(x,y,\overline{n−1})) (1)

Extrapolate is a non parametric extrapolation function, estimating the value of each pixel in the new image given the preceding space-time volume. This extrapolation should use the dynamics constancy assumption, as will now be described.

When the camera is moving, the image transformation induced by the camera motion should be added to this equation. Assuming that all frames in the space time volume V(x,y,\overline{n−1}) are aligned to the coordinate system of the (n−1)^{th} frame, the new image Iₙ (x, y) can be approximated by:
Iₙ≈Tₙ(Extrapolate(V(x,y,\overline{n−1}))) (2)

Tₙ is a 2D image transformation between frames Iₙ₋₁ and Iₙ, and is applied on the extrapolated image. Applying the inverse transformation on both sides of the equation gives:

$${T}^{- 1} ( {I}_{n} ) \approx Extrapolate ( V ( x , y , \vec{n - 1} ) ) \qquad ( 3 )$$

This relation is used in the registration scheme.

### Video Extrapolation

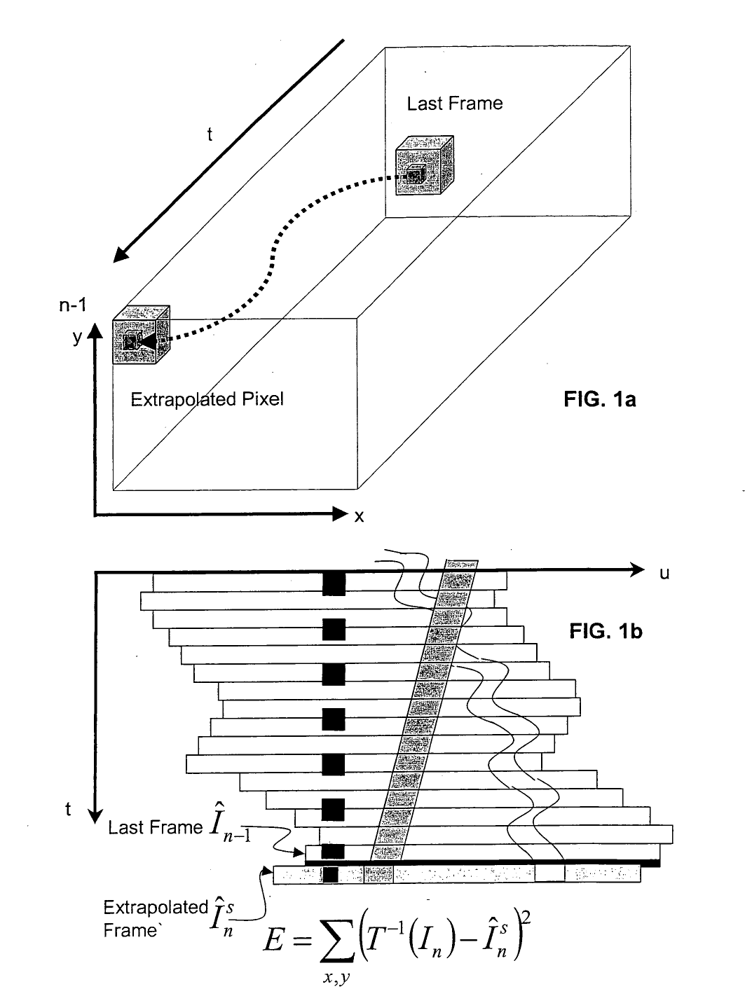

Our video extrapolation is closely related to dynamic texture synthesis [4, 1]. However, dynamic textures are characterized by repetitive stochastic processes, and do not apply to more structured dynamic scenes, such as walking people. We therefore prefer to use non-parametric video extrapolation methods [10, 5, 8]. These methods assume that each small space-time block has likely appeared in the past, and thus the video can be extrapolated using similar blocks from earlier video portions. This is demonstrated in FIGS. 1a and 1b. Various video interpolation or extrapolation methods differ in the way they enforce spatio-temporal consistency of all blocks in the synthesized video. However, this problem is not important in our case, as our goal is to achieve a good alignment rather than a pleasing video.

Leaving out the spatio-temporal consistency requirement, we are left with the following simple video extrapolation scheme: assume that the aligned space time volume V(x,y,\overline{n−1}) is given, and a new image Iₙ^{p} is to be estimated. For each pair of space-time blocks Wₚ and W_{q} we define the SSD (sum of square differences) to be:

$$d ( {W}_{p} , {W}_{q} ) = {\sum }_{( x , y , t )} {( {W}_{p} ( x , y , t ) - {W}_{q} ( x , y , t ) )}^{2} \qquad ( 4 )$$

As shown in FIG. 1, for each pixel (x, y) in image Iₙ₋₁ we define a space-time block W_{x,y,n-1} whose spatial center is at pixel (x, y) and whose temporal boundary is at time n−1. We then search in the space time volume V(x,y,\overline{n−2}) for a space-time block with the minimal SSD to block. W_{x,y,n-1} Let Wₚ=W(xₚ, yₚ, tₚ) be the most similar block, spatially centered at pixel (xₚ, yₚ) and temporally bounded by tₚ. The value of the extrapolated pixel Iₙ^{p}(x, y) will be taken from V(xₚ, yₚ, tₚ₊₁), the pixel that appeared immediately after the most similar block. This scheme follows the “dynamics constancy” assumption: given that two different space time blocks are similar, we assume that their continuations are also similar. While a naive search for each pixel may be exhaustive, several accelerations can be used as described below.

We used the SSD (sum of square differences) as a distance measure between two space-time blocks, but other distance measures can be used such as the sum of absolute differences or more sophisticated measures ([10]). We did not notice a substantial difference in registration results.

### Alignment with Video Extrapolation

The online registration scheme for dynamic scenes uses the video extrapolation described earlier. As already mentioned, we assume that the image motion of a few frames can be estimated with traditional robust image registration methods [7]. Such initial alignment is used as “synchronization” for computing the motion parameters of the rest of the sequence. Alignment with Video Extrapolation can be described by the following operations:
1. Assume that the motion of the first K frames has already been computed, and let n=K+1.
2. Align all frames in the space time volume V(x,y,(\overline{n−1})) to the coordinate system of Frame Iₙ₋₁.
3. Estimate the next new image by extrapolation from the previous frames Iₙ^{p}=Extrapolate(V(x,y,(\overline{n−1}))).
4. Compute the motion parameters (the global 2D image transformation Tₙ⁻¹) by aligning the new input image Iₙ to the extrapolated image Iₙ^{p}.
5. Increase n by 1, and return to operation 2. Repeat until reaching the last frame of the sequence.

The global 2D image alignment in operation 2 is performed using direct methods for parametric motion computation [2, 7].

### Masking Unpredictable Regions

Real scenes always have a few regions that cannot be predicted. For example, people walking in the street often change their behavior in an unpredictable way, e.g. raising their hands or changing their direction. In these cases the video extrapolation will fail, resulting in outliers. The alignment can be improved by estimating the predictability of each region, where unpredictable regions get lower weights during the alignment stage. To do so, we incorporate a predictability score M(x, y, t) which is estimated during the alignment process, and is later used for future alignment.

The predictability score M is computed is the following way: after the new input image Iₙ is aligned with the extrapolated image which estimated it, the difference between the two images is computed. Each pixel (x, y) receives a predictability score according to the color differences in its neighborhood. Low color differences indicate that the pixel has been estimated accurately, while large differences indicate poor estimation. From these differences a binary predictability mask is computed, indicating the accuracy of the extrapolation,

$$M ( x , y , n ) = \{ \begin{matrix}1 & if \frac{\sum {( {I}_{n} - {I}_{n}^{p} )}^{2}}{\sum ( {I}_{x}^{2} + {I}_{y}^{2} )} \\ 0 & otherwise\end{matrix} < r \qquad ( 5 )$$

where the summation is over a window around (x, y), and r is a threshold (typically r=1). This is a conservative scheme to mask out pixels in which the residual energy will likely bias the registration. The predictability mask Mn(x, y)=M (x, y, n) is used in the alignment of frame Iₙ₊₁ to frame Iₙ₊₁^{p}.

### Fuzzy Estimation

Applications such as video completion or video compression also use frame predictions. Unlike these applications, video registration is not limited to use a single prediction. Instead, better alignment can be obtained when a fuzzy prediction is used. The fuzzy prediction can be obtained by keeping not only the best candidate for each pixel, but the best S candidates. One embodiment of the invention reduced to practice used up to five candidates for each pixel. The multiple predictions for each pixel can easily be combined using a summation of the error terms:

$${T}_{n} = arg {min}_{T} \{ {\sum }_{x , y , s} {{λ}_{x , y , s} ( {T}^{- 1} ( {I}_{n} ) ( x , y ) - {I}_{n}^{p} ( x , y , s ) )}^{2} \} \qquad ( 6 )$$

where Iₙ^{p}(x,y,s) is the s^{th} candidate for the value of the pixel Iₙ(x,y). The weight λ_{x,y,s} of each candidate is based on the difference of its corresponding space-time cube from the current one as defined in Eq. 4, and is given by:

$${λ}_{x , y , s} = {ⅇ}^{\frac{- {d ( {W}_{p} , {W}_{q} )}^{2}}{2 {σ}^{2}}} \qquad ( 7 )$$

We used σ= 1/255 to reflect the noise in the image gray levels. Note that the weights for each pixel do not necessarily sum to one, and therefore the registration mostly relies on the most predictable regions.

### Accelerating the Video Extrapolation

The most expensive stage of the dynamic registration is finding the best candidates in the video extrapolation stage. An exhaustive search makes this stage very slow. To enable fast extrapolation we have implemented several modifications which accelerate substantially this stage. Some of these accelerations may not be valid for general video synthesis and completion techniques, as they can reduce the rendering quality of the resulting video. But high rendering quality is not essential for accurate registration.

Limited Search Range: Video sequences can be very long, and searching the entire history may not be practical. Moreover, the periodicity of most objects is usually of a short time period. We have therefore limited the search for similar space-time cubes to a small volume in both time and space around each pixel. Typically, we searched up to 10-20 frames backwards (periods of approximately one second).

Using Pyramids: We assume that the spatio-temporal behavior of objects in the video can be recognized even in a lower resolution. Under this assumption, we construct a Gaussian pyramid for each image in the video, and use a multi-resolution search for each pixel. Given an estimate of a matching cube from a lower resolution level, we search only in a small spatial area in the higher resolution level. The multi-resolution framework allows to search in a wide spatial range and to compare small space-time cubes.

Summed Area Tables: Since the video extrapolation uses a sum of squares of values in sub-blocks in both space and time (See Eq. 4), we can use summed-area tables [3] to compute all the distances for all the pixels in the image in O(N·Sₓ·S_{y}·Sₜ) where N is the number of pixels in the image, and Sₓ, S_{y} and Sₜ are the search ranges in the x, y and t directions respectively. This saves the factor of the window size (typically 5×5×5) over a direct implementation. This operation cannot be used together with the multi-resolution search, as the lookup table changes from pixel to pixel, but it can still be used in the lowest resolution level, where the search range is the largest.

### Handling Alignment Drift

Alignment based on Video Extrapolation follows Newton's First Law: an object in uniform motion tends to remain in that state. If we initialize our registration algorithm with a small motion relative to the real camera motion, our method will continue this motion for the entire video. In this case the background will be handled as a slowly moving object. This is not a bug in the algorithm, but rather a degree of freedom resulting from the “dynamics constancy” assumption. To eliminate this degree of freedom we incorporate a prior bias, and assume that some of the scene is static. This is done by aligning the new image to both the extrapolated image and the previous image, giving the previous image a low weight. In our experiments we gave a weight of 0.1 to the previous frame and a weight of 0.9 to the extrapolated frame. This prior prevented the possible drift, while not reducing the accuracy of motion computation.

### EXAMPLES

In this section we show various examples of video alignment for dynamic scenes. A few examples are also compared to regular direct alignment as in [2, 7]. To show stabilization results in print, we have averaged the frames of the stabilized video. When the video is stabilized accurately, static regions appear sharp while dynamic objects are ghosted. When stabilization is erroneous, both static and dynamic regions are blurred.

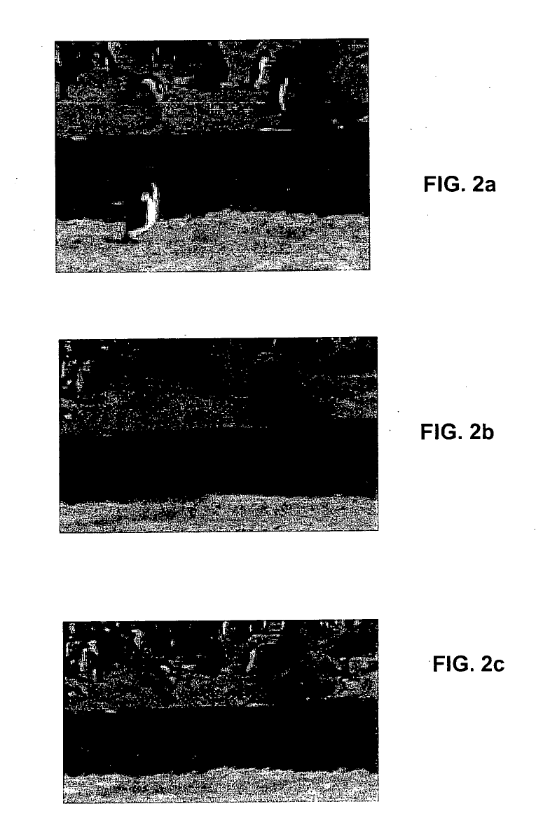

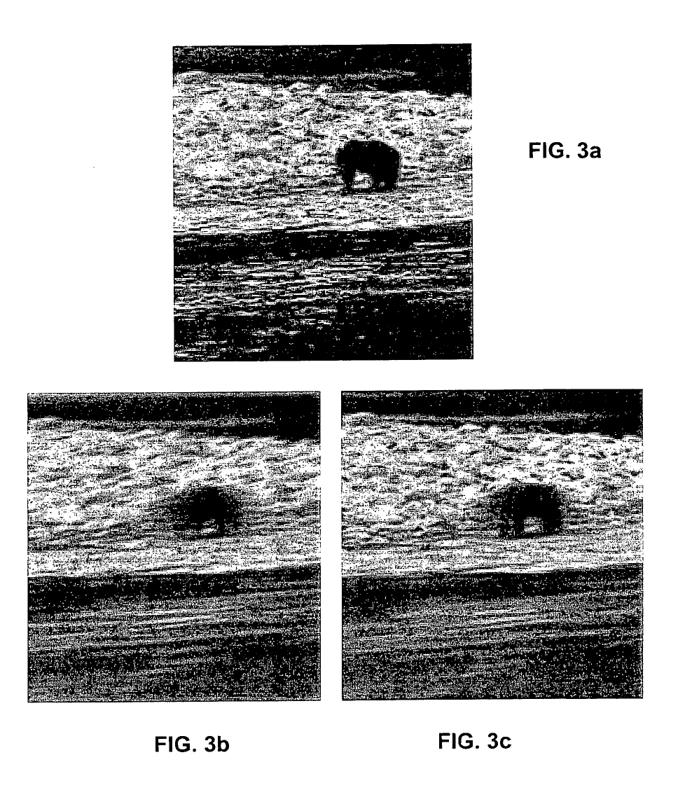

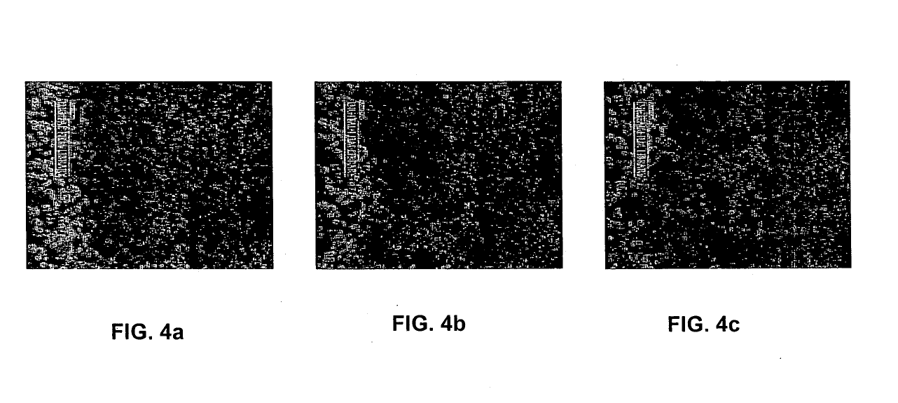

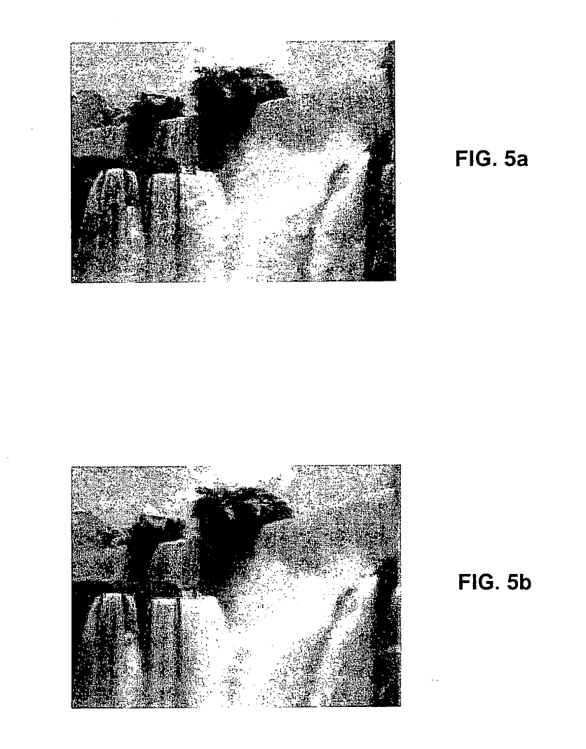

FIGS. 2 and 3 compare the registration using video extrapolation with traditional direct alignment [2, 7]. Specifically, FIGS. 2a and 3a show pictorially a video frame of a penguin and bear, respectively, in flowing water, FIGS. 2b and 3b show pictorially image averages after registration of the video using a prior art 2D parametric alignment, and FIGS. 2c and 3c show the respective registrations using extrapolation according to an embodiment of the invention.

Both scenes include moving objects and flowing water, and a large portion of the image is dynamic. In spite of the dynamics, after video extrapolation the entire image can be used for the alignment. For this comparison, in these examples we did not use any mask to remove unpredictable regions nor did we use a fuzzy estimation, but rather used the entire image for the alignment.

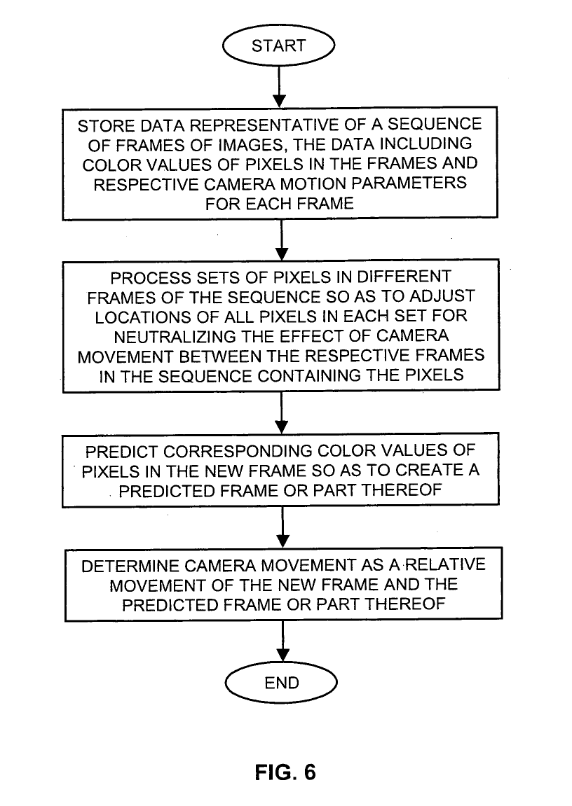

FIGS. 4a, 4b and 4c show three frames from a sequence of moving flowers taken by a panning camera.

The sequence shown in FIG. 4 was used by [9] and by [6] as an example for their registration of dynamic textures. The global motion in this sequence is a horizontal translation, and the true displacement can be computed from the motion of one of the flowers. The displacement error reported by [9] was 29:4% of the total displacement between the first and last frames, while the error of our methods was only 1:7%.

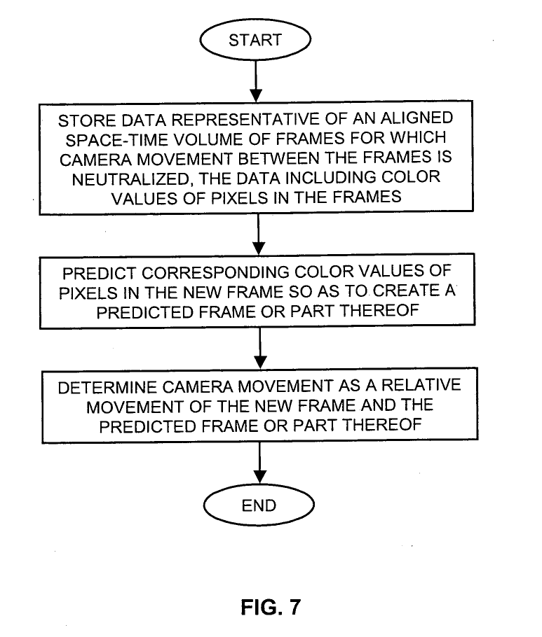

FIGS. 5a and 5b show respectively original frame of waterfall sequence and an image average after stabilizing the sequence according to an embodiment of the invention

In these scenes, the estimation of some of the regions was not good enough, namely parts of the falls and the fumes, so predictability masks (as described above) were used to exclude unpredictable regions from the motion computations.

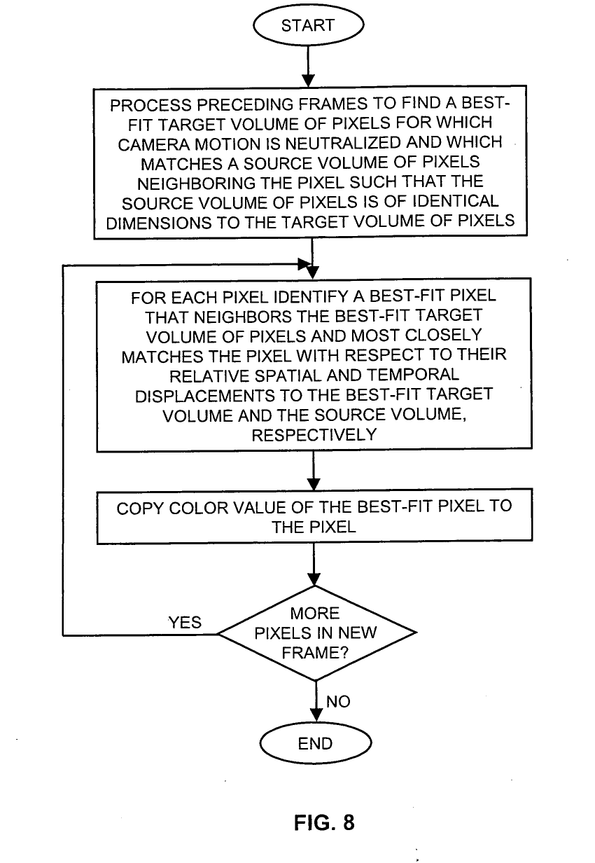

FIG. 6 shows pictorially a method in accordance with an embodiment of the invention for determining camera movement of a new frame relative to a sequence of frames of images containing at least one dynamic object and for which relative camera movement is assumed. Color values of sets of pixels in different frames of the sequence are extracted for which respective locations of all pixels in each set are adjusted so as to neutralize the effect of camera movement between the respective frames in the sequence containing the pixels. As will be explained in more detail with reference to FIG. 7, relative camera movement may be assumed by storing parameters in respect of each frame indicative of camera movement relative to the respective frame; or the frames may be pre-processed so as to neutralize camera movement and then stored as an aligned space-time volume. From changes in color values between the corresponding pixels in each set, corresponding color values of the pixels in the new frame are predicted so as to create a predicted frame or part thereof. Data representative of the predicted frame or part thereof are stored and camera movement is determined as a relative movement of the new frame and the predicted frame or part thereof.

FIG. 7 shows pictorially a method in accordance with another embodiment of the invention for determining camera movement of a new frame relative to a sequence of frames of images containing at least one dynamic object. In this case, camera movement relative to the frame sequence is neutralized so as to create an aligned space-time volume of frames. From changes in color values of pixels in different frames of the aligned space-time volume, corresponding color values of the pixels in a new frame are predicted so as to create a predicted frame or part thereof, which allows camera movement to be determined as a relative movement of the new frame and the predicted frame or part thereof.

Once camera movement is known, it is then possible to neutralize relative camera movement between at least two frames so as produce a stabilized video, which when displayed is free of camera movement. This is particularly useful to eradicate the effect of camera shake. However, neutralizing relative camera movement between at least two frames may also be a precursor to subsequent image processing requiring a stabilized video sequence. Thus, for example, it is possible to compute one or more computed frames from at least two frames taking into account relative camera movement between the at least two frames. This may be done by combining portions of two or more frames for which relative camera movement is neutralized, so as to produce a mosaic containing parts of two or more video frames, for which camera movement has been neutralized. It may also be done by assigning respective color values to pixels in the computed frame as a function of corresponding values of aligned pixels in two or more frames, for which camera movement has been neutralized. Likewise, the relative camera movement may be applied to frames in a different sequence of frames of images or to portions thereof. Frames or portions thereof in the sequence of frames may also be combined with a different sequence of frames.

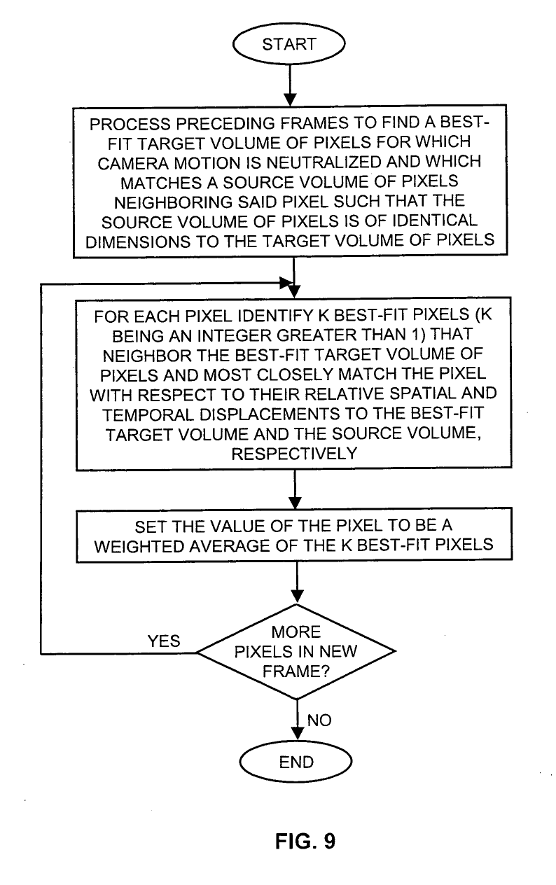

FIG. 8 is a flow diagram showing the principal operations carried out in accordance with an embodiment of the invention for predicting corresponding color values of pixels in a new frame. Preceding frames are processed to find a best-fit target volume of pixels for which camera motion is neutralized and which matches a source volume of pixels neighboring a pixel in the new frame (whose color value is to be predicted) such that the source volume of pixels is of identical dimensions to the target volume of pixels. This is shown pictorially in FIG. 1a.

A best-fit pixel is then identified that neighbors the best-fit target volume of pixels and most closely matches the currently processed pixel in the new frame with respect to their relative spatial and temporal displacements to the best-fit target volume and the source volume, respectively. In this context, again with reference to FIG. 1a, it is seen that the volume comprises at least portions of different video frames each obtained at different times and “stacked” along the time axis. Thus, the best-fit pixel and currently processed pixel in the new frame must match with regard to both their relative spatial and temporal displacements to the respective pixel volumes. A color value of the best-fit pixel is then copied to the currently processed pixel in the new frame and the process is repeated for other pixels in the new frame.

FIG. 9 is a flow diagram showing the principal operations carried out in accordance with an alternative embodiment of the invention for predicting corresponding color values of pixels in a new frame. Preceding frames are processed as shown pictorially in FIG. 1a to find the K best-fit volumes of pixels for which camera motion is neutralized and which matches a source volume of pixels neighboring a pixel in the new frame (whose color value is to be predicted) such that the source volume of pixels is of identical dimensions to the target volume of pixels.

K best-fit pixels are then identified, where K is a positive integer, that neighbor the K best-fit target volumes of pixels. The value of the currently proceed pixel in the new frame is then set to be a weighted average of the K best-fit pixels, or any other function using those K best fit pixels. One of the K-best-fit pixels may be taken to be a pixel in an identical spatial location in one of the preceding frames.

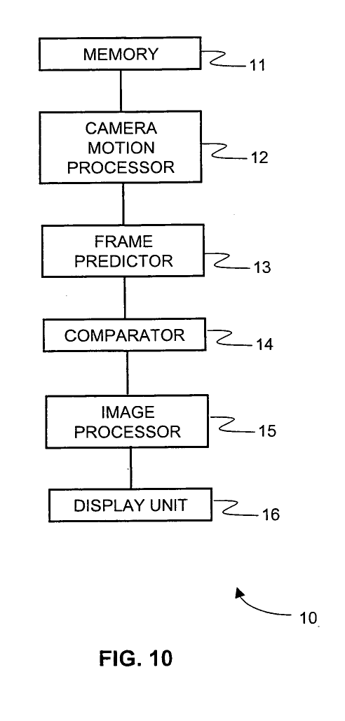

FIG. 10 is a block diagram showing functionality of a system 10 according to an embodiment of the invention for determining camera motion relative to a sequence of image frames. The system comprises a memory 11 for storing data representative of a sequence of frames of images, the data including color values of pixels in the frames and respective camera motion parameters for each frame. A camera motion processor 12 is coupled to the memory 1I for processing sets of pixels in different frames of the sequence so as to adjust locations of all pixels in each set for neutralizing the effect of camera movement between the respective frames in the sequence containing the pixels. A frame predictor 13 is coupled to the camera motion processor 12 for predicting corresponding color values of the pixels in the new frame so as to create a predicted frame or part thereof. A comparator 14 coupled to the frame predictor 13 determines camera movement as a relative movement of the new frame and the predicted frame or part thereof.

In an alternative embodiment, the memory 11 stores data representative of an aligned space-time volume of frames for which camera movement between the frames thereof is neutralized. In this case, the frame predictor 13 is responsive to changes in color values of pixels in different frames of the aligned space-time volume for predicting corresponding color values of the pixels in a new frame so as to create a predicted frame or part thereof.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

### Concluding Remarks

An approach for video registration of dynamic scenes has been presented. The dynamics in the scene can be either stochastic as in dynamic textures, or structured as in moving people. Intensity changes such as flickering can also be addresses. The frames in such video sequences are aligned by estimating the next frame using video extrapolation from the preceding frames.

Video extrapolation for alignment can be done much faster than other video completion approaches, resulting in a robust and efficient registration. The examples show excellent registration for very challenging dynamic images that were previously considered impossible to align. Most methods which address videos with multiple dynamic patterns use a segmentation of the scene. Owing to its non-parametric nature, the proposed approach can find the motion parameters without any segmentation.

The proposed video extrapolation is different from image prediction used for video compression in the following aspects:
The main objective of the video extrapolation in our case is to minimize the motion bias rather than the prediction error.
An estimation of the gray-values at a sparse set of image locations is sufficient for accurate registration, while it is not applicable for compression.
Unlike video compression methods which compute the optical flow between current and previous frames, our video extrapolation does not use the current frame. This is due to the fact that such an optical flow would mix between the camera motion and the scene dynamics.

1. A computer-implemented method for determining camera movement of a new frame relative to a sequence of frames of images containing at least one dynamic object and for which relative camera movement is assumed, said method comprising:
from changes in color values of sets of pixels in different frames of said sequence for which respective locations of all pixels in each set are adjusted so as to neutralize the effect of camera movement between the respective frames in said sequence containing said pixels, predicting corresponding color values of said pixels in the new frame so as to create a predicted frame or part thereof;
storing data representative of the predicted frame or part thereof; and
determining said camera movement as a relative movement of the new frame and the predicted frame or part thereof.

2. The method according to claim 1, further including neutralizing relative camera movement between at least two frames.

3. The method according to claim 2, further including displaying said at least two frames or parts thereof.

4. The method according to claim 1, further including generating at least one computed frame from at least two frames taking into account relative camera movement between said at least two frames.

5. The method according to claim 4, wherein generating at least one computed frame includes combining portions of said at least two frames for which relative camera movement is neutralized.

6. The method according to claim 4, wherein generating at least one computed frame includes assigning respective color values to pixels in the computed frame as a function of corresponding values of aligned pixels in said at least two frames.

7. The method according to claim 1, further including applying the relative camera movement to frames in a different sequence of frames of images or to portions thereof.

8. The method according to claim 17, further including combining frames or portions thereof in said sequence of frames and said different sequence of frames.

9. The method according to claim 1, wherein predicting corresponding color values of said pixels in a new frame includes for each of said pixels:
processing preceding frames to find a best-fit target volume of pixels for which camera motion is neutralized and which matches a source volume of pixels neighboring said pixel such that the source volume of pixels is of identical dimensions to the target volume of pixels;
identifying a best-fit pixel that neighbors the best-fit target volume of pixels and most closely matches said pixel with respect to their relative spatial and temporal displacements to the best-fit target volume and the source volume, respectively; and
copying a color value of the best-fit pixel to said pixel.

10. The method according to claim 1, wherein predicting corresponding color values of said pixels in a new frame includes for each of said pixels:
processing preceding frames to find a best-fit target volume of pixels for which camera motion is neutralized and which matches a source volume of pixels neighboring said pixel such that the source volume of pixels is of identical dimensions to the target volume of pixels;
identifying K best-fit pixels (K being a positive integer) that neighbor the K best-fit target volumes of pixels and most closely match said pixel with respect to their relative spatial and temporal displacements to the best-fit target volume and the source volume, respectively; and
setting the value of the pixel to be a weighted average of said K best-fit pixels.

11. The method according to claim 10, wherein one of the K-best-fit pixels is taken to be a pixel in an identical spatial location in one of the preceding frames.

12. A computer-implemented method for determining camera movement relative to a sequence of frames of images containing at least one dynamic object and for which there exists an aligned space-time volume of frames for which camera movement between said frames is neutralized, said method comprising:
from changes in color values of pixels in different frames of the aligned space-time volume, predicting corresponding color values of said pixels in a new frame so as to create a predicted frame or part thereof;
storing data representative of the predicted frame or part thereof; and
determining said camera movement as a relative movement of the new frame and the predicted frame or part thereof.

13. The method according to claim 12, further including:
neutralizing camera movement in the new frame; and
adding the new frame to the aligned space-time volume.

14. The method according to claim 13, further including displaying at least two frames in the aligned space-time volume or parts thereof.

15. The method according to claim 12, further including generating at least one new frame from different frames in the aligned space-time volume.

16. The method according to claim 15, wherein generating at least one new frame includes combining portions of different frames in the aligned space-time volume.

17. The method according to claim 15, wherein generating at least one new frame includes assigning respective color values to pixels in the new frame as a function of corresponding values of pixels in different frames in the aligned space-time volume.

18. The method according to claim 12, wherein predicting corresponding color values of said pixels in a new frame includes for each of said pixels:
processing the aligned space-time volume of frames to find a best-fit target volume of pixels matching a source volume of pixels neighboring said pixel such that the source volume of pixels is of identical dimensions to the target volume of pixels;
identifying a best-fit pixel that neighbors the best-fit target volume of pixels and most closely matches said pixel with respect to their relative spatial and temporal displacements to the best-fit target volume and the source volume, respectively; and
copying a color value of the best-fit pixel to said pixel.

19. The method according to claim 12, wherein predicting corresponding color values of said pixels in a new frame includes for each of said pixels:
processing the aligned space-time volume of frames to find a best-fit target volume of pixels matching a source volume of pixels neighboring said pixel such that the source volume of pixels is of identical dimensions to the target volume of pixels;
identifying K best-fit pixels (K being a positive integer) that neighbor the K best-fit target volumes of pixels and most closely match said pixel with respect to their relative spatial and temporal displacements to the best-fit target volume and the source volume, respectively; and
setting the value of the pixel to be a weighted average of said K best-fit pixels, or other function of them.

20. The method according to claim 19, wherein one of the K-best-fit pixels is taken to be a pixel in an identical spatial location in one of the preceding frames.

21. A computer-implemented program storage device readable by machine, tangibly embodying a program of instructions executable by the machine to perform a method for determining camera movement of a new frame relative to a sequence of frames of images containing at least one dynamic object and for which relative camera movement is assumed, said method comprising: from changes in color values of sets of pixels in different frames of said sequence for which respective locations of all pixels in each set are adjusted so as to neutralize the effect of camera movement between the respective frames in said sequence containing said pixels, predicting corresponding color values of said pixels in the new frame so as to create a predicted frame or part thereof; and
determining said camera movement as a relative movement of the new frame and the predicted frame or part thereof.

22. A computer-implemented computer program product comprising a computer useable medium having computer readable program code embodied therein for determining camera movement of a new frame relative to a sequence of frames of images containing at least one dynamic object and for which relative camera movement is assumed, said computer program product comprising:
computer readable program code responsive to changes in color values of sets of pixels in different frames of said sequence for which respective locations of all pixels in each set are adjusted so as to neutralize the effect of camera movement between the respective frames in said sequence containing said pixels, for causing the computer to predict corresponding color values of said pixels in the new frame so as to create a predicted frame or part thereof, and
computer readable program code for causing the computer to determine said camera movement as a relative movement of the new frame and the predicted frame or part thereof.

23. A computer-implemented program storage device readable by machine, tangibly embodying a program of instructions executable by the machine to perform a method for determining camera movement relative to a sequence of frames of images containing at least one dynamic object and for which there exists an aligned space-time volume of frames for which camera movement between said frames is neutralized, said method comprising:
from changes in color values of pixels in different frames of the aligned space-time volume, predicting corresponding color values of said pixels in a new frame so as to create a predicted frame or part thereof; and
determining said camera movement as a relative movement of the new frame and the predicted frame or part thereof.

24. A computer-implemented computer program product comprising a computer useable medium having computer readable program code embodied therein for determining camera movement relative to a sequence of frames of images containing at least one dynamic object and for which there exists an aligned space-time volume of frames for which camera movement between said frames is neutralized, said computer program product comprising:
computer readable program code responsive to changes in color values of pixels in different frames of the aligned space-time volume, for causing the computer to predict corresponding color values of said pixels in a new frame so as to create a predicted frame or part thereof; and
computer readable program code for causing the computer to determine said camera movement as a relative movement of the new frame and the predicted frame or part thereof.

25. A system for determining camera movement of a new frame relative to a sequence of frames of images containing at least one dynamic object and for which relative camera movement is assumed, said system comprising:
a memory for storing data representative of said sequence of frames of images, said data including color values of pixels in said frames and respective camera motion parameters for each frame;
a camera motion processor coupled to said memory for processing sets of pixels in different frames of said sequence so as to adjust locations of all pixels in each set for neutralizing the effect of camera movement between the respective frames in said sequence containing said pixels;
a frame predictor coupled to said camera motion processor for predicting corresponding color values of said pixels in the new frame so as to create a predicted frame or part thereof; and
a comparator coupled to the frame predictor for determining said camera movement as a relative movement of the new frame and the predicted frame or part thereof.

26. A system for determining camera movement relative to a sequence of frames of images containing at least one dynamic object, said system comprising:
a memory for storing data representative of an aligned space-time volume of frames for which camera movement between said frames is neutralized, said data including color values of pixels in said frames;
a frame predictor coupled to said memory and responsive to changes in color values of pixels in different frames of the aligned space-time volume for predicting corresponding color values of said pixels in a new frame so as to create a predicted frame or part thereof; and
a comparator coupled to the frame predictor for determining said camera movement as a relative movement of the new frame and the predicted frame or part thereof.
